(19) United States
(12) Patent Application Publication
(10) Pub. No.: US 2015/0312353 A1
(43) Pub. Date: Oct. 29, 2015

(54) DRIVER-TO-DRIVER COMMUNICATION SYSTEM, VEHICLE, AND METHOD THEREOF

(71) Applicant: GM GLOBAL TECHNOLOGY OPERATIONS LLC, Detroit, MI (US)

(72) Inventors: Lu Chen, Shanghai (CN); Jiang Du, Beaverton, OR (US); Xiaowen Dai, Troy, MI (US); Peggy Wang, Shanghai (CN)

(73) Assignee: GM GLOBAL TECHNOLOGY OPERATIONS LLC, Detroit, MI (US)

(21) Appl. No.: 14/648,170

(22) PCT Filed: Nov. 30, 2012
(86) PCT No.: PCT/CN2012/085606

§ 371 Date: May 28, 2015

(51) Int. Cl. H04L 29/08; G06K 9/00; H04N 5/232

(52) U.S. Cl. CPC H04L 67/141; H04L 67/12; H04N 5/23229; G06K 9/00201

(57) ABSTRACT

A driver-to-driver communication system includes a server accessible over a communications network, a first vehicle, and a second vehicle. The first vehicle and the second vehicle each have a license plate with a license plate number. The license plate numbers are stored on the server. The first vehicle may be substantially behind the second vehicle, and may be configured to send the second license plate number to the server. This may be accomplished by a computer device, which includes a camera to detect and read the second license plate number. A processor recognizes the second license plate number and sends it to the server over the communications network via a wireless module. The server matches the second license plate number with the second vehicle, and subsequently establishes communication, either direct or indirect, between the first vehicle and the second vehicle.

### TECHNICAL FIELD

The present invention relates to a system, a vehicle, and a method for drivers of vehicles in close proximity to each other to communicate, where the system is based on the license plate number of one of the vehicles.

### BACKGROUND

There are often multiple vehicles on a road, where one vehicle is either in front or behind another vehicle. Oftentimes, the driver of a first vehicle may want to communicate with the driver of a second vehicle. For example, where the first vehicle is behind the second vehicle, the first driver may want to inform the second driver that there is an issue with the second driver's car of which he may not be aware. The driver of the second vehicle may also want to make an announcement to the first driver or any other driver of a vehicle behind the second vehicle. Currently, there are various methods and devices for drivers to communicate and/or share information with each other while operating their vehicles. Such methods and devices may include, but are not limited to, speaking over a mobile phone or citizens' band (CB) radio, transferring data via mobile phones over 3G, 4G, or other mobile telecommunications network, dedicated short-range communications (DSRC), and the like.

### SUMMARY

A system for a first vehicle and a second vehicle to communicate with each other is provided. The system includes at least one server that is hosted by an administrator and that is accessible over a communication network. The first vehicle has at least one license plate with a first license plate number. Likewise, the second vehicle has at least one license plate with a second license plate number. The first license plate number and the second license plate number are stored on the at least one server, and are associated with the first vehicle and the second vehicle, respectively. The first vehicle may be substantially behind the second vehicle, and as such, may be configured to detect, read, and transmit the second license plate number to the server. In turn, the server is configured to match the second license plate number with the second vehicle, and subsequently establish communication, either direct or indirect, between the first vehicle and the second vehicle.

The first vehicle may further include a first computer device. The first computer device may have at least one camera to detect and read the second license plate number. The first computer device may also include at least one processor to recognize the second license plate number, either through image recognition of images received from the at least one camera, or through automatic speech recognition (ASR). The first computer device may further include a wireless module to transmit the second license plate number to the server over the communications network. The first computer device may further include a communication module configured to enable the first vehicle to communicate with the second vehicle and with the server.

The second vehicle also may be configured to detect, read, and transmit the first license plate number to the server. As such, the second vehicle may include the same components, such as the first computer device, as the first vehicle described above. The server, in turn, may be further configured to match the first license plate number with the first vehicle, and subsequently establish communication, either direct or indirect, between the second vehicle and the first vehicle.

A first vehicle configured to communicate with a second vehicle is also provided. The second vehicle has at least one license plate with a license plate number. The first vehicle generally includes the same structure and components as the first vehicle described above.

A method of establishing communication between a first vehicle and a second vehicle is further provided. The first vehicle and the second vehicle may be as described above, specifically having license plates with a first license plate number and a second license plate number, respectively. The method includes storing on at least one server the first license plate number and the second license plate number. The at least one server is accessible over a communications network. The first license plate number and the second license plate number are associated on the at least one server with the first vehicle and the second vehicle, respectively.

The method then includes receiving, by the at least one server, the second license plate number from the first vehicle. As explained above, the first vehicle may have a first computer device that includes at least one camera to detect and read the second license plate number.

The method then includes matching the second license plate number with the second vehicle, based on the associating of the second license plate number with the second vehicle on the server. The method then includes establishing communication, either direct or indirect, between the first vehicle and the second vehicle and/or the server. The first vehicle may communicate directly with the second vehicle. Alternatively, the first vehicle may transmit a message to the server, which in turn transmits the message to the second vehicle. Alternatively, the second vehicle may transmit a message to the server, which in turn stores the message on the server, and associates it with the second vehicle. After the server establishes a connection with the first vehicle, the server may transmit the stored message to the first vehicle.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, system diagram of a communication system for a first vehicle and a second vehicle;

FIG. 2 is a block diagram of an exemplary vehicle representative of the first vehicle and the second vehicle of FIG. 1;

FIG. 3 is a schematic, front view of an exemplary license plate of the vehicle of FIG. 2; and

FIG. 4 is a schematic flow diagram illustrating an exemplary method of enabling communication between the first vehicle and the second vehicle via the communication system of FIG. 1.

### DETAILED DESCRIPTION

Those having ordinary skill in the art will recognize that terms such as “above,” “below,” “upward,” “downward,” et cetera, are used descriptively of the figures, and do not represent limitations on the scope of the invention, as defined by the appended claims. Any numerical designations, such as “first” or “second” are illustrative only and are not intended to limit the scope of the invention in any way.

Referring to the drawings, wherein like reference numbers correspond to like or similar components wherever possible throughout the several figures, a communication system 10, enabling a first driver 12 to communicate, either directly or indirectly, with a second driver 14, and vice versa, is provided. The communication system 10 generally includes a server 16 hosted by an administrator 18, a first vehicle 20, and a second vehicle 22. The first vehicle 20 is driven by the first driver 12, and the second vehicle 22 is driven by the second driver 14. The first driver 12, the second driver 14, and the server 16/administrator 18 all communicate and/or transfer data with each other over a communications network 24.

The communication system 10 is described hereinafter with the first vehicle 20 and the second vehicle 22 being oriented such that the first vehicle 20 is immediately behind the second vehicle 22, i.e., there are no other vehicles or obstructions between the first vehicle 20 and the second vehicle 22. However, it should be appreciated that the first vehicle 20 and the second vehicle 22 are interchangeable in the description of the communication system 10 hereinafter. It should further be appreciated that the communication system 10 may be applicable where the first vehicle 20 and the second vehicle 22 are in close enough proximity with each other that the license plate number of either vehicle is visible and readable by the other vehicle or the driver of the other vehicle, as explained in more detail hereinafter.

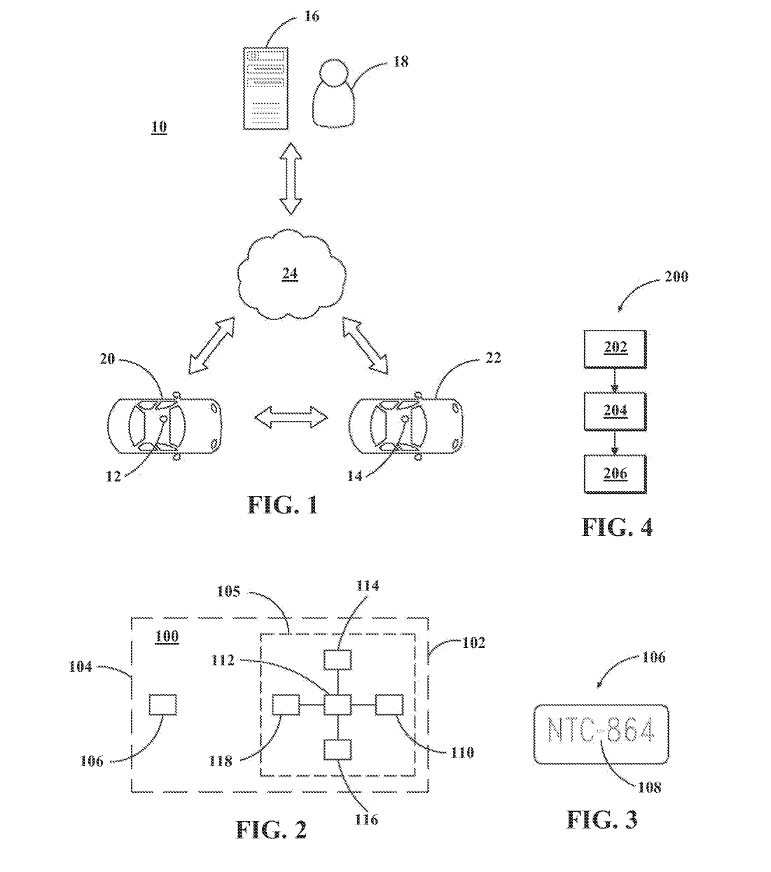

The server 16 stores the license plate numbers 108, as depicted in FIG. 3 and described hereinafter, of the first vehicle 20 and the second vehicle 22. The license plate numbers 108 are associated with their respective vehicle 20 and 22, as well as with any other data, including verbal and visual messages, associated with the vehicles 20 and 22. The server 16 generally is any device that may have processors, program logic or other substrate configurations to perform a function or an action, and/or to cause a function or action to occur. Specifically, the server may include, but is not limited to, controller circuitry, processor circuitry, processors, general purpose single-chip or multi-chip microprocessors, digital signal processors, embedded microprocessors, microcontrollers, integrated circuits, application specific integrated circuits, discrete logic, and the like. While FIG. 1 depicts only one server 16, it should be appreciated that the communication system 10 may include any number of servers 16 in communication with the communications network 24. The servers 16 may be located at the same location or at different locations, and may implement any form or variant of a cloud computing and/or Software as a Service (SaaS) platform or model.

As mentioned above, the server 16 is accessible over the communications network 24. The communications network 24 may be a partial or full deployment of any communication/computer network or link. For example, the network may include, but is not limited to, network elements from a Public Switch Telephone Network (PSTN), the Internet, core and proprietary public networks, wireless voice and packet-data networks, such as 1G, 2G, 2.5G, 3G, 4G and 4G LTE advanced telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANS), including, but not limited to, Bluetooth and/or IEEE 802.11 WLANs, wireless personal area networks (WPANs), wireless metropolitan area networks (WMANs), and the like.

The server 16 may be connected to the communications network 24 via a router, transmitter and receiver, transceiver, or any other device (not shown) known to connect to any of the networks described above.

The first vehicle 20 and the second vehicle 22 generally have the same structure and components. As such, an exemplary vehicle 100, representative of both the first vehicle 20 and the second vehicle 22, is shown in FIG. 2. The vehicle 100 generally has a front end 102 and a rear end 104. The vehicle 100 has a license plate 106 at the rear end 104. The license plate 106 generally is made up of a combination of letters and numerals that form a license plate number 108. An exemplary license plate 106 with a license plate number 108 is depicted in FIG. 3.

The vehicle 100 further has a computer device 105 with which the communication system 10 may be operated. The computer device 105 may be, but is not limited to, a mobile device, such as a cellular phone, smart phone, personal data assistant (PDA), tablet, or the like, or a general computer, having the same or similar structure as the server 16 described above. The general computer device may be embodied in an existing computer system of the vehicle 100, such as a navigation system, infotainment system, and the like.

The computer device 105 may generally include a camera 110, a processor 112, a wireless module 114, a communication module 116, and a global positioning system (GPS) 118. The computer device 105 may also include application software that is operable to interact with the server 16 through the communications network 24. The application software may be obtained from any source, including, but not limited to, a third party website or application. Alternatively, the application software may be pre-loaded in the computer device 105. The computer device 105 may further include a hard drive (not shown) to store any data and information, such as the application software.

The camera 110 is configured to read and detect the license plate number 108 of another vehicle 100 in front of it. As such, the camera 110 is generally located at the front end 102 of the vehicle 100, and is positioned in any orientation and alignment capable of reasonably viewing the license plate 106 and license plate number 108 of the other vehicle 100. For example, in one configuration, the camera 110 may be disposed within a front grille of the vehicle 100. In another configuration, the camera 110 may be disposed within a windshield of the vehicle 100.

In another embodiment not shown, the vehicle 100 may include an additional license plate 108 at the front end 102 of the vehicle 100. As such, the vehicle 100 may further include an additional camera 110 at the rear of the vehicle 100 to read and detect the license plate number 108 of another vehicle 100 behind it. As with the camera 110 at the front end 102 of the vehicle 100, the camera 110 at the rear end 104 is positioned in an orientation and alignment capable of reasonably viewing the license plate 106 and license plate number 108 of the other vehicle 100 behind it. For example, in one configuration, the additional camera 110 may be in a rear bumper of the vehicle 100. This may allow the second driver 14 to initiate communication with the first driver 12, as described in more detail hereinafter.

The camera(s) 110 may have one or more lenses and/or filters adapted to receive and/or shape light onto an image sensor. The image sensor may include, for example, at least one charge-coupled device (CCD) configured to convert light energy into a digital signal. The license plate camera(s) 110 is configured to capture and output a single image of the license plate 106, and specifically the license plate number 108, of the other vehicle 100, or a video feed, which may include, for example, a plurality of still image frames that are sequentially captured at a fixed rate (i.e., frame rate). The single image or the video feed of the license plate number 108 is transmitted to the processor 112.

The processor 112 may be located anywhere within the vehicle 100. The processor 112 may perform functions for only the communication system 10, or may be configured to perform other tasks required by the vehicle 100. While one processor 112 is shown in FIG. 2, it should be appreciated that there may be any number of processors 112 to perform the necessary tasks.

The processor 112 may be embodied as one or multiple digital computers or data processing devices, each having one or more microprocessors or central processing units (CPU), read only memory (ROM), random access memory (RAM), electrically-erasable programmable read only memory (EEPROM), a high-speed clock, analog-to-digital (A/D) circuitry, digital-to-analog (D/A) circuitry, input/output (I/O) circuitry, power electronics/transformers, and/or signal conditioning and buffering electronics. As explained above, the processor 112 may receive the image and/or video feed of the license plate number 108 from the camera(s) 110. Using one or more image processing techniques and/or algorithms, the processor 112 may recognize the letters and numerals making up the license plate number 108. The processor may then transmit the resultant data to the server 16 over the communications network 24 via the wireless module 114.

The wireless module 114 is configured to transmit and receive communications and data from the server 16 and/or another vehicle 100 over the communications network 24. The wireless module 114 may be, but is not limited to, a transceiver, a transmitter and a receiver, or any other device capable of connecting to any of the networks described above.

The communication module 116 is configured to enable the first driver 12 and the second driver 14 to communicate directly with each other, or indirectly through the server 16. The communication module 116 may include, but is not limited to, a speakerphone, a microphone, a speaker, or any combination thereof. The communication module 116 may also be integrated with an audio system of the vehicle 100 such that any data and/or communications from the driver of the other vehicle 100, and/or the administrator 18, may be played over the speakers of the car. The communication module 116 may further include a monitor to display the data and/or communications. It may also include an input module, which may be integrated with the monitor having touch screen capability, enabling the driver to manually enter the license plate number 108 of the vehicle 100 in front or behind the driver's vehicle 100, or to manually enter a message and/or other communication.

The communication module 116 is wired to the processor 112. In addition to image recognition and processing, the processor 112 further may be configured, through automatic speech recognition (ASR) technology and/or algorithms, to transmit and receive a verbal message, a textual message, or a combination thereof, to and from the driver via the communication module 116 from and to the server 16 via the wireless module 114. In doing so, the processor 112 may convert the verbal message into an audio format, including, but not limited to, WAV, AIFF, MP3, WMA, and the like. The processor 112 also may be configured to translate the verbal message into a textual message via an on-board or cloud based ASR technology. The processor 112 further may be configured to enable direct communication between the driver and the driver of the other vehicle 100 via the wireless module 114.

Referring back to the system diagram of FIG. 1, the first driver 12 may initiate the communication system 10 either through manual detection of the license plate number 108 of the second vehicle 22, or through automatic detection. Manual detection may occur when the first vehicle 20 is within close enough proximity to the second vehicle 22 that the first driver 12 may identify the license plate number 108. The first driver 12 may then transmit the license plate number 108 to the server 16 via the computer device 105 to be matched with the second vehicle 22 to initiate communication, as described in method 200 hereinafter. As explained above, this may be communicated verbally, for example, via an on-board or cloud-based ASR technology input, or through a textual input via the computer device 105.

Automatic detection may occur when the first vehicle 20 is within close enough proximity to the second vehicle 22 that the camera 110 may detect and read the license plate number 108 of the second vehicle 22. After processing the image or video feed received from camera 110, the computer device 105 may then automatically transmit the license plate number 108 to the server 16 via the wireless module 114.

In one embodiment, the first driver 12 may initiate automatic detection by selecting an option from the application software on the computer device 105. Alternatively, the first driver may initiate automatic detection through a voice command. This may be a standalone voice-based system for the communication system 10, or may be integrated into an existing voice-based system in the first vehicle 20.

In another embodiment, the communication system 10 may be configured such that the camera 110 is taking a constant stream of images or a video feed, and sending them to the processor 112. Once the processor is able to recognize a combination of letters and numerals that make up a license plate number 108 from the images or video feed, then it will transmit the license plate number 108 to the server 16.

The second driver 14 may also initiate the communication system 10. As explained above, the first vehicle 20 may have a license plate 106 on the front end 102, and the second vehicle 22 may have a camera 110 on the rear end 104 of the second vehicle 22. Thus, in scenarios in which the second driver 14 would desire to communicate with the first driver 12, the second driver 14 may initiate the communication system 10 through either manual detection or automatic detection of the license plate number 108 of the first vehicle 20, similar to initiation of the communication system 10 by the first driver 12.

Alternatively, the second driver 14 may choose to first communicate with and transmit a message to the server 16/administrator 18. The message is stored on the server 16 and is associated with the license plate number 108 of the second vehicle 22. When a first driver initiates the communication system 10 by any of the detection methods described above, the server 16 will transmit the stored message to the first driver 12 to be played via the communication module 116.

Both the first driver 12 and the second driver 14 may selectively opt in to participate in the communication system 10 or opt out at any given time. Where the second driver 14 is not participating when the first driver 12 attempts to initiate communication, the server 16 may notify the first diver 12 that the second driver 14 is not available for communication. The first driver 12 may transmit a message to be stored on the server 16, as described above, which may then transmit the message to the second driver 14 when he opts in. The same is true if the second driver 14 attempts to communicate with the first driver 12 when he is not participating in the communication system 10 at the time of the attempted initiation of communication.

Referring now to FIG. 4, a method 200 for establishing communication between a first driver 12 of a first vehicle 20 and a second driver 14 of a second vehicle 22 is shown. As explained above, the first vehicle 20 is immediately behind the second vehicle 22. Each vehicle has a license plate 106 with a license plate number 108 on it.

Prior to the start of method 200, the license plate numbers 108 of the first vehicle 20 and the second vehicle 22 are registered with the administrator 18 such that they are stored on the server 16 and are associated with the respective vehicles 20 and 22. Method 200 begins after the initiation of the communication system 10 by the first driver 12, as described above.

Method 200 begins at step 202 in which the server 16 receives from the first driver 12 and/or the first vehicle 20, depending on the detection method, the license plate number 108 of the second vehicle 22. As explained above, the first driver 12 may verbally transmit the license plate number 108 to the server 16 via the computer device 105 after the first driver 22 has read the license plate number 108. Alternatively, the camera 110 may detect and read the license plate number 108, and the processor 112 may subsequently send the license plate number 108 to the server 16.

After step 202, method 200 proceeds to step 204. At step 204, the server 16 matches the license plate number 108 with the second vehicle 22 based on the information stored on the server 16.

After step 204, method 200 proceeds to step 206. At step 206, the server 16 establishes communication between the first driver 12 and the second driver 14. The communication may be direct, where the first driver 12 and the second driver 14 are directly communicating with each other.

Alternatively, the communication may be indirect, where the first driver 12 first transmits a message to the server 16, and the server 16 subsequently transmits the message to the second driver 14. For example, the first driver 12 may comment on and/or rate the driving behaviors of the second driver 14, which may be relayed to the second driver 14. In addition, the comments regarding the driving behaviors of the second driver 14 may be stored and associated with the license plate number 108 of the second vehicle 22 on the server 16. This may allow future drivers whose vehicles are subsequently behind the second vehicle 22 to receive and review the comments and/or ratings such that they may be made aware of the driving behaviors of the second driver 14. This may be irrespective of the second driver 14 being aware of the comments and/or ratings, such as in a scenario in which he does not download or otherwise receive them.

As another form of indirect communication, the second driver 14 may transmit a message to the server 16 to be stored and associated with the second vehicle 22 on the server 16. As explained above, this may be in an audio format, or as a textual message. The server 16 then may transmit the stored message to the first driver 12.

Alternatively, the server 16 may relay the message received from the second driver 14 to the first driver 12 almost immediately after receiving it, such that it is not permanently stored on the server 16. Rather, the message may be temporarily stored on the server 16 so that it may be relayed to the first driver 12, and then removed from the server 16 after the first driver 12 has received it.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A system for a first vehicle and a second vehicle to communicate with each other, the system comprising at least one server hosted by an administrator, the server accessible over a communications network;
wherein the first vehicle has at least one license plate with a first license plate number on it, the first license plate number being stored and associated with the first vehicle on the at least one server;
wherein the second vehicle has at least one license plate with a second license plate number on it, the second license plate number being stored and associated with the second vehicle on the at least one server;
wherein the first vehicle is substantially behind the second vehicle, and is configured to transmit the second license plate number to the at least one server; and
wherein the server is programmed to match the second license plate number with the second vehicle, and the server is programmed to establish communication between the first vehicle and the second vehicle.

2. The system of claim 1 wherein the first vehicle further comprises a first computer device, and the second vehicle further comprises a second computer device.

3. The system of claim 2 wherein the first computer device comprises at least one camera configured to detect and read the second license plate number.

4. The system of claim 3 wherein the first computer device further comprises at least one processor to recognize the second license plate number through the use of at least one of an image recognition algorithm or an automatic speech recognition algorithm.

5. The system of claim 4 wherein the first computer device further comprises a wireless module to transmit the second license plate number from the at least one processor to the at least one server over the communications network.

6. The system of claim 2 wherein the first computer device and the second computer device each further comprise a communication module configured to enable the first vehicle and the second vehicle to communicate with each other and with the server.

7. The system of claim 2 wherein the second vehicle is configured to communicate the first license plate number to the at least one server.

8. The system of claim 7 wherein the second computer device comprises at least one camera configured to detect and read the first license plate number.

9. The system of claim 8 wherein the second computer device further comprises at least one processor to recognize the first license plate number detected and read by the at least one camera.

10. The system of claim 9 wherein the second computer device further comprises a wireless module to transmit the first license plate number from the at least one processor to the at least one server over the communications network.

11. The system of claim 7 wherein the at least one server is further configured to match the first license plate number with the first vehicle, and establish communication between the second vehicle and the first vehicle.

12. A first vehicle configured to communicate with a second vehicle having at least one license plate with a license plate number, the first vehicle comprising:
at least one camera configured to detect and read the license plate number of the second vehicle;
at least one processor to recognize, through the use of at least one of an image recognition algorithm or an automatic speech recognition algorithm, the license plate number; and
a wireless module to transmit the license plate number to a server on which the license plate number is stored and is associated with the second vehicle, the server being accessible over a communications network; and
a communication module configured to enable the first vehicle to communicate with at least one of the second vehicle and with the server.

13. A method of establishing communication between a first vehicle having a license plate with a first license plate number, and a second vehicle having a license plate with a second license plate number, the method comprising:
storing on at least one server the first license plate number and the second license plate number, the first license plate number and the second license plate number being associated with the first vehicle and the second vehicle, respectively;
receiving, by the at least one server, the second license plate number from the first vehicle;
matching the second license plate number with the second vehicle; and
establishing communication between the first vehicle and at least one of the server and the second vehicle;
wherein the at least one server is accessible over a communications network.

14. The method of claim 12 wherein the first vehicle further comprises a first computer device, and the second vehicle further comprises a second computer device.

15. The method of claim 14 wherein the first computer device comprises at least one camera configured to detect and read the second license plate number.

16. The method of claim 15 wherein the first computer device further comprises at least one processor to recognize the second license plate number through the use of at least one of an image recognition algorithm or an automatic speech recognition algorithm.

17. The method of claim 16 wherein the first computer device further comprises a wireless module to transmit the second license plate number to the server over the communications network.

18. The method of claim 14 wherein the first computer device and the second computer device each comprise a communication module configured to enable the first vehicle and the second vehicle to communicate with each other and with the server.

19. The method of claim 12 further comprising receiving and storing at least one message received from the second vehicle, the at least one message being associated with the second license plate number.

20. The method of claim 19 further comprising transmitting the at least one message to the first vehicle after establishing communication between the first vehicle and the server.
